(19) United States
(12) Patent Application Publication
(10) Pub. No.: US 2016/0092977 A1
(43) Pub. Date: Mar. 31, 2016

(54) PREFERENTIAL INTERNET AUCTION SYSTEM ON BASIS OF BID PARTICIPATION TIME

(71) Applicant: Young Nam PARK, (US)

(72) Inventor: Young Nam PARK, Seoul (KR)

(21) Appl. No.: 14/778,933

(22) PCT Filed: Mar. 21, 2014
(86) PCT No.: PCT/KR2014/002419

§ 371 Date: Dec. 9, 2015

(30) Foreign Application Priority Data
Mar. 21, 2013 (KR) 10-2013-0030541
Mar. 21, 2013 (KR) 10-2013-0030545

(51) Int. Cl. G06Q 30/08

(52) U.S. Cl. CPC G06Q 30/08

(57) ABSTRACT

The present invention relates to an Internet auction system for mediating and managing the purchase and sale of product by receiving bid information from a plurality of customer terminals via a communication network. The system includes: a product registration and management module for receiving information on a product to be auctioned off from a seller terminal and storing the received information; a product bid management module, as a product bid module, for receiving bid information from the customer terminals and storing the received bid information, wherein the bid information includes a bidding price; and a preferential successful bid management module for allowing a customer who has more possession time than other customers to preferentially receive a successful bid of the product.

### TECHNICAL FIELD

The present invention relates to internet auction system based on participation time to allow someone to buy the item prior to others. Also the present invention relates to online bidding system for get discount on bid price proportional to number of multiple bidding.

### BACKGROUND

On a previous auction system, sellers put on the item on an auction brokerage server with descriptions. Consumers would bid with a certain price of their own. Within a time limit highest bidder would win the auction.

By using the auction method, sellers can sell the item at the highest value, and buyers can buy the unfixed price of the item at the lowest value against other bidders that unknown items can be purchased cheap. Basically buyers can have fun by making their own prices to obtain the item with a satisfaction. Consumers not only buy the items cheap but also they can have fun by deciding their own prices subjectively for the items.

Meanwhile the operator of bidding brokerage server mainly makes profits from the broker's fee when more bidders bid and higher bidding price is set. For online auction, in addition to this, the brokers make money via advertisement shown to consumers and sellers visiting the website.

In order to maximize the profits for consumers, sellers, and brokers times of bidding trials or many visitors are required.

However, previous online auction is different from offline auction that there are problems of being concentrated of biddings when they are almost at the end of the auction. Even though bidders have participated from the beginning of the auction, the item will be sold to a highest bidder when the auction time is ended. All the bidders keep track of the ending time of the auction, and they focus on bidding for the item at the end of the auction to achieve It. Therefore, the bidding doesn't occur throughout the whole auction evenly. Only at a certain time (usually at the end of the auction). So it is impossible to have bidding times more than certain numbers of trials. Furthermore, if at a certain time the bidding is concentrated the number of visitors on the website would deduct. It is difficult to have profits via advertisement.

There is also group purchase method such as social commerce to purchase products in cheap price. There are advantages of many people purchasing products at the same time that the price goes down, and massive products can be sold. Also different products are sold every day that advertisement profit would increase due to many advertisements shown to many visitors.

However, even with this method of selling products, consumers would be concentrated at the finishing sales period that the are still not solved. Also discount price is fixed by sellers that consumers cannot decide the price. Only under certain conditions, the discounts are available. Unlike the auction consumers' purchasing actions don't apply directly to the discounts of products, so consumers cannot enjoy subjectively deciding the price of products.

There are demands of technology where deciding product price subjectively on consumers' side and prohibiting many buyers concentrated at the end of product sales from the standard product sales method.

### DETAILED DESCRIPTION

### Technological Subjects

As described, on a regular online auction, there are difficulties of having advertisement profits due to visitors staying on the website less and using overall bidding time of process efficiently due to many buyers are driven at the end of auction.

The present invention would solve these difficulties. The present invention would Induce consumers to participate in an overall auction period, and has a purpose to make visitors stay on the website longer to maximize the advertisement profits.

Furthermore, the present invention would allow consumers actively participate in deciding discount price of products through their own bidding actions that consumers can have satisfaction.

### Technical Solution

In order to achieve above purpose, the present invention discloses an internet auction system for mediating and managing the purchase and sale of product by receiving bid information from a plurality of customer terminals via a communication network comprises a product registration and management module for receiving information on a product to be auctioned off from a seller terminal and storing the received information; a product bid management module for receiving bid information from the customer terminals and storing the received bid information, wherein the bid information includes a bidding price; and a preferential successful bid management module for allowing a customer who has more possession time than other customers to preferentially receive a successful bid of the product. And the preferential successful bid management module comprises a possession time calculation module for calculating a possession time for each customer terminal, and the possession time is the time in which a received bidding price maintains the highest bidding price.

Also internet auction system according to the present invention includes a price discount management module determining winning bids by deducted as discount price from the bidding starting price according to counts for receiving the bidding information from consumer terminals.

### Advantageous Effect

According to the present invention, the longer consumer participates in the auction, there is a better chance of winning the auction. Since the buyers would stay online not only the at the end of the auction but also participate in the auction consistently from the beginning of it that it Is efficient to encourage bidders to stay on the auction more. Also, bidders would stay on the website longer that advertisement profit would increase.

Also according to the present invention, sellers can decide the time of consumers staying for bidding arbitrarily that seller can control and/or induce consumers to stay on the website as long as they want.

Furthermore, according to the present invention, there would be a discount as much as they participate in the bidding. Consumers would get discounts and sellers can sell more products as much as they give out discounts at the same time.

Also auction brokers can make profit by selling bid right apart from brokerage fee and advertisement profit that a new format of profitable business could be created.

Furthermore, consumers can advertise the active bidding action because based on their bidding reaction the products would be discounted. Through the subjective bidding reaction there would be virtuous circulation of more consumers participating in an auction.

### BRIEF DESCRIPTION ON DRAWINGS

FIG. 1 shows an application and fundamental of discount system and online auction to intermediate and manage sales, discount, and purchase of products after receiving bidding information from multiple consumers' terminals through communication network according to the present invention.

FIG. 2 shows a component of internet auction system according to the present invention

FIG. 3 shows a layout of consumers' terminals of person A, B, C's participation in internet auction system from consumers' terminals.

FIG. 4 shows about participation time and participation time calculation method desirable conducted examples would be described below.

FIG. 5 shows a conducted example on weighted values/deducted values about possession time.

FIG. 6 shows a conducted example for weighted values/deducted values about participation time.

### DETAILED DESCRIPTION

Conducted examples of the present invention would be explained referring to below figures.

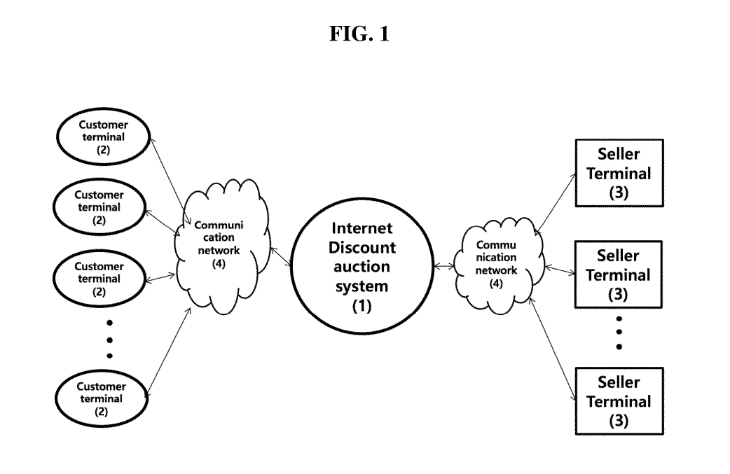

FIG. 1 shows concept explaining an application and fundamental of discount system and online auction to intermediate and manage sales, discount, and purchase of products after receiving bidding information from multiple consumers' terminals through communication network according to the present invention.

Referring to the FIG. 1, internet (discount) auction system (1) according to the present invention such as a server computer, in data processing system includes data transmitter/receiver, memory storage, processor, etc. The communication network (4) includes installed coaxial cable, fiber optic cable, LAN, Wi-Fi, bluetooth, 3G, 4G (LTE, etc.), etc. for wire and wireless communication, all of components providing environment transmitting/receiving Information (data).

In FIG. 1, internet auction system (1) is connected to through multiple consumers' terminals (2), multiple sellers' terminals (3) through communication network (4).

Consumer's terminal (2) participates in (bids) online auction by connecting to internet auction system through communication network. From here, participating in (bidding) means that consumers select specific products and transmit their expectation prices (bidding prices). According to the present invention, an action of participation in the bidding means receiving and saving bidding information from consumers' terminals. In the preferable embodiment of the present invention, an auction of participation in the bidding means that transmitting bid right information to bid right management module of product bidding management module (13).

Seller's terminal (3) registers products which are the objects of auction after accessing internet auction system (1) through communication network. Registration means sellers transmit information of items to sell to a product registration management module (11) of internet auction system (1).

Consumers' terminals (2) and sellers' terminals (3) are information processing system like computers, and according to preferable embodiment of the present invention, consumers' terminals (2) are cell phones usually called smart phones and sellers' terminals (3) are personal computers.

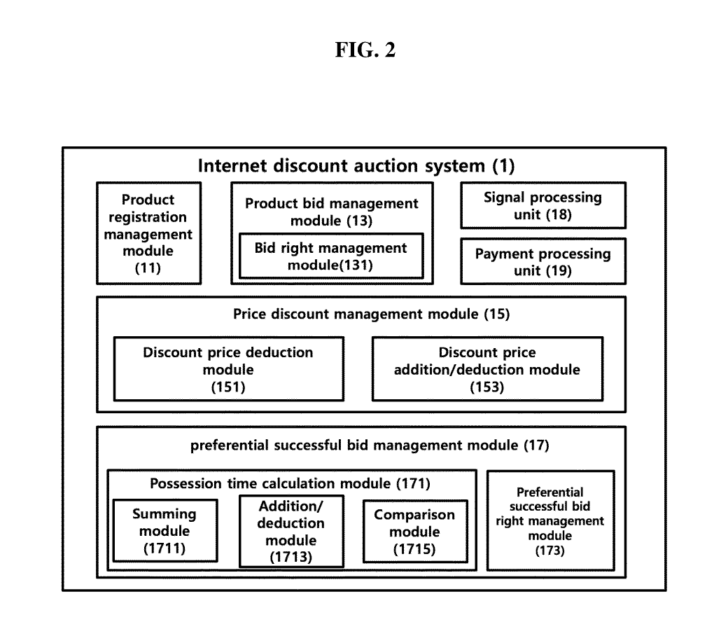

FIG. 2 shows a block diagram representing of components of internet auction system according to the present invention.

Like drawn on FIG. 2, internet auction system (1) according to the present invention basically includes product registration management module (11), product bidding management module (13), price discount management module (15) and preferential successful bid management module (17).

Prior to specific description of each component, it is preferably right to induce consumers and sellers to sign up as members of the system to manage. The related technology is noticed in electronic commerce industry, so detailed description would be omitted.

Product registration management module (11) receives from sellers' terminal and stores (registers) information on the product relating to auctions. Information on the product means for example not only names, kinds, sizes and colors of the product, but also all information to characterize the product. Product registration management module (11) registers these kinds of information. When consumers' terminal search about it, all related information will be send to consumers' terminals (2) through signal processing unit (18), so all information on certain products are shown to consumers' terminals (2).

Based on a preferable embodiment, the information on products include prices of products. Depending on what kind of auctions (an auction starting bidding at 0 won) the input of product price may not be necessary. For examples when an auction starts the minimum price can be written. When the maximum price is registered all consumers who had bid at the maximum price can obtain the products.

As another preferable embodiment of the present invention, information on the product may include an auction period. The auction period means a period from a possible bidding start moment (start of an auction) to appointed time selected by the seller (end of an auction). In general, the highest price after the auction period has been completed is called a bid price. This characteristic may be used for giving weighted value and/or deducted value based on auction period through possession time addition/deduction module.

Product bidding management module (13) receives and stores bidding information from consumers' terminals (2). Bidding means that consumers have joined the process of bidding by suggesting an appropriate price for the product. In the present invention consumers represent their will to join the process of bidding by transmitting digitalized information to internet auction system (1) from consumers' terminals (2). As a preferable embodiment of the present invention, said bidding Information includes a bid price. The bid price means the price of the product which consumers would like to purchase when they hope to bid. If bidding process has been going on for several times, at every bidding process, bid prices exist. In general, if multiple bidding process have been taken places in the auction, the later registered bid price is higher than the previous auction price. According to a preferable embodiment of the present invention, consumers represent their intention by transmitting bid price information as bid information to product bidding management modules.

As a preferable embodiment of the present invention, said product bidding management module includes bid right ding ticket management module (131, or bid right management module) providing bid right information to consumers' terminals by answering to the request of consumers' terminals. Also through above bid right management module (131) bidding information given to consumers' terminals receives and stores bidding information. Said bid right information is a kind of a ticket suggested by consumers' terminals (2) for consumers to participate in a bidding. Through predetermined ways, the tickets would be given from ticket management module (131). Eventually the way of getting bid right information is that through describable payment processing unit (19) or certain amount of cost (hereafter called bidding cost) should be paid. Bidding information having identification information will be sent to consumers' terminals (2). As a preferable embodiment of the present invention, bid right management module (131) confirms each terminal having bid right information at every bidding, or once bid right information is given certain numbers of possible bidding can be established. For example, after paying 1000 won for bidding payment to buy bid right from bid right management module (131), the corresponding consumers' terminals (2) can be established as bidding up to 2 times by using the bid right information.

In the bidding method according to the present invention, bidding starting price is determined that every bidding discount of product can be taken. Due to this, there are chance of having too much discount through thoughtless bidding trials. Therefore, through this kind of bidding cost giving bid rights, the thoughtless bidding could be stopped. Operators of online discount auction system (1) can have additional profits through bidding costs instead of advertisement or product sales payment. Furthermore, on consumers' side, relatively bidding cost would be less than discount price of product that consumers can participate in the auction without any burdens. Also when the product is bid the buyer can have bigger profit than bidding cost.

Through price discount management module (15), said bid price (subtracting discounted price from bidding starting price) is determined, auction winner first is determined through preferential successful bid management module (17).

Preferential successful bid management module (17) calculates possession time by each consumer so that a consumer with more possession times can be allowed to purchase product first (to won bids first). For example, after 30 minutes since bidding has started, person A tendered bid, and person B tendered bids after 10 minutes, and another 5 minutes later person C tendered bids much higher than before. In that case, person A gets 10 minutes of possession time, person B for 5 minutes (person C's possession time would last until next bid is made). More detailed explanation about possession time which decides who has priority over whom will be followed.

In the present invention, possession time means that the time kept a consumer's bid price which input through consumer's terminal of the highest bid price. In other words, possession time means the time from when a consumer's the highest bid price is registered to when another consumer bid higher. Like this, the highest bid price constantly would change as bidding keeps going on, and the time during highest price sustained would be considered as possession time, which means the time bidder temporarily possessed the product.

In the preferable embodiment of the present invention, possession time is calculated by possession time calculation module (171). Especially through possession time summing module (1711) in possession time calculation module (171), possession time is calculated by adding up all possession time of each consumer while the auction was going on.

In another embodiment of the present invention, said possession time summing module according to auction time separates possession time of each consumer. One consumer's possession time could be added to another consumer's possession time. In this case, certain consumer's terminal (2) may transmit some of one's possession time to another person by transmitting intention of possession time transfer to possession time summing module (1711).

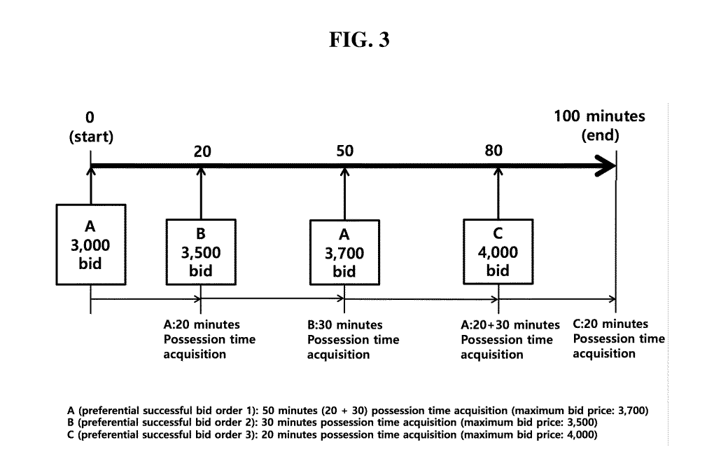

The preferable embodiment of possession time and possession time calculation method would be explained as below with a reference of FIG. 3. FIG. 3 shows a diagram representing consumers' terminals of person A, B and C's participation in internet auction system from consumers' terminals as auction time has passed. Total auction time is 100 minutes, and bid starting price is 0. From FIG. 3, person A initiated the bid with 3,000 won as a bid price. In this case 3,000 won which person A input would be the highest bidding price at the moment. From this time on, possession time of person A starts counting. After 20 minutes have passed, person B bid the item for 3,500 won. At that time, the possession time of A ended, and the possession time of B starts counting. Till this time person A's possession time is 20 minutes. After 50 minutes have passed since auction had started, person A bids for 3,700 won. The price of person A's bid, 3,700 won, is more than 3,500 won, the person B's bid price which was the highest price for a moment. The possession time of person B has ended, person A's started. Till this time the total possession time for person B is 30 minutes. Since the auction has started 80 minutes have passed, person C bids the item for 4,000 won. Of course 4,000 won is the highest auction price that person A's possession time ends and person C's possession time started. Till this, person A's possession time is total 50 minutes, person B has 30 minutes. When the auction has ended the bid price of 4,000 by person C remained as highest price that person C gets possession time of 20 minutes. The possession sum time for person A is 50 minutes, B is 30 minutes, and C is 20 minutes. The orders are A->B->C.

The participation time of involvement in an auction can be calculated by referring to log of communication network like internet. Furthermore, in preferential successful bid management module sellers may set up the settings of the auction that after a new price is registered for certain time no one can bid again.

Also there is another setup which can be established when two consumers bid at the same time, the person with higher bid gets to be registered. There is another option where a setup allows in a certain time period, consumers can bid. After certain bidding time has finished, the highest bidder takes the whole possession time of the period of the auction.

According to another preferable embodiment of the present invention instead of described possession time, an additional discount could be taken out from the bidding prices proportionally to number of bid based on participation time.

In the embodiment, preferential successful bid management module (17) gives chance to purchase (to be won bids) product before anyone else by having most participation time through calculation of each consumer. As below, the participation time which determines order of preferential successful bids is described.

In the present invention, participation time means the time from the last bidding point of compulsory consumers' terminals to another consumer's next bidding time. For example, after an auction has started, 30 minutes later, person A made a bid, and 10 minutes afterward person B bid a new price. After 5 min since person B had made a bid, person C had joined the bidding competition. Person A's participation time is 10 minutes, and person B's participation time is 5 minutes (person C's participation time would last till the next bidding trial).

According to embodiment of the present invention, a consumer with more participation time at the end of auction gets products with higher discount than other consumers preferentially. If there are only 5 products, and 10 consumers have made a bid. Out of 10, 5 people with most participation time would get the 5 products. Like so comparison of participation time among consumers would be described through participation time comparison module (1715′).

In this embodiment, participation time is calculated through participation calculation module (171′), and especially through participation time summing module (1711′) of participation time calculation module (171′) sum up all participation time in auction period by consumers. Operation method of described possession time calculation module (171) and participation time calculation module (171′) are similar that they use same symbols but separated by (′). (For simplicity of the figures, (′) is ignored in figures)

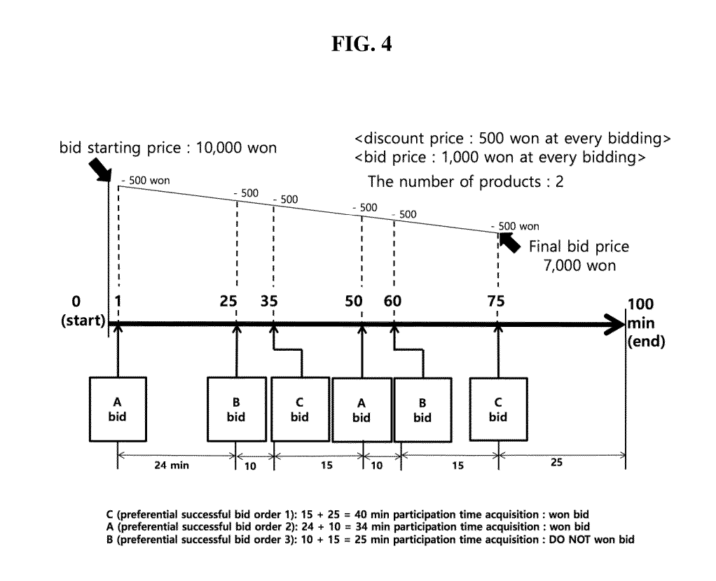

Referring to FIG. 4, about participation time and participation time calculation method desirable examples would be described below.

In FIG. 4, starting price is 10,000 won, and there are 2 products. This information on products are registered by transmitted from product registration management module (11) through sellers' terminals (3).

First, a discount price needs to be calculated. In embodiment of the present invention, consumer pay through payment processing unit (19) or other payment method noticed and receives bid right information through bidding management module (131) because when bidding information input from consumers' terminal (2), 1,000 won of bidding payment is needed. Price discount management module (15) takes out discount price of 500 won from auction starting price whenever bidding information is received (when bidding) from consumers' terminals through discount price deduction module (151). In the FIG. 4, person A tenders bids twice totally at 1 and 50 minutes after the auction starts respectively. Likewise, after an auction had started person B made bids twice at 25 minutes and 60 minutes after auction starts, person C made bids at 35 minutes and 75 minutes after auction starts. Total auction time is 100 minutes. From FIG. 4, total number of bids are 6, total discount price (the discount price) is 500 won*6 that it is 3,000 won. When the auction is finished the bid price is 7,000 won.

Next, consumers who can purchase products is decided with 7,000 won above. Products are 2 pieces, but consumers participated in the auction are 3 persons. So bidder is determined by the giving priority. Preferential successful bid management module (17) sum up each consumer's participation time through participation time calculation module (17) (specifically its participation time summing module (1711′)). From FIG. 4, participation time of person A is 34 minutes which are sum of 24 and 10, participation time of person B is 25 minutes which are sum of 10 and 15, participation time of person C are 40 minutes which are sum of 15 and 25. Participation time comparison module (1715′) giving priorities by comparing these consumers' participation time. All of said participation time comparison among consumers first place is taken by person C, 2nd place is for person A, and last person B. From the result above, for the first time person C can purchase product with the discounted price with 7,000 won above, after person C, person A can purchase the product. If both person C and A purchase the products, then person B cannot purchase it.

From described in the FIG. 4, person A and C used 2,000 Won to tender bids twice. And they got discounts of 3,000 won that eventually products were purchased 1,000 won cheaper. If there were more bidders, then there would have been more discounts but order of priority of person A and C might have been lowered.

Person B used 2,000 won but did not win an auction that bid rights of 2,000 won may be returned to bid in different auction through bid rights.

Participation time can be determined with a log of communication network like internet. Further, preferential successful bid management module (17) may establish that others cannot bid until certain time has passed after specific person has put down a bidding price.

In desirable embodiment, said preferential successful bid management module (17) may assign weighted values and deducted values for participation time according to auction period by consumers through participation time addition/deduction module (1713′). This is to vitalize auction participation that detail information is same as described discount price addition/deduction module (153).

In desirable example, said preferential successful bid management module (17) can assign weighted values and deducted values for participation time according to auction period by consumers through participation time addition/deduction module (1713′). This is to vitalize auction participation. In general, because more bidding occurs at the end of an auction than in the beginning if weighted values in the beginning of an auction for participation time of consumers then more active bidders can be induced from the beginning to have active auction participation.

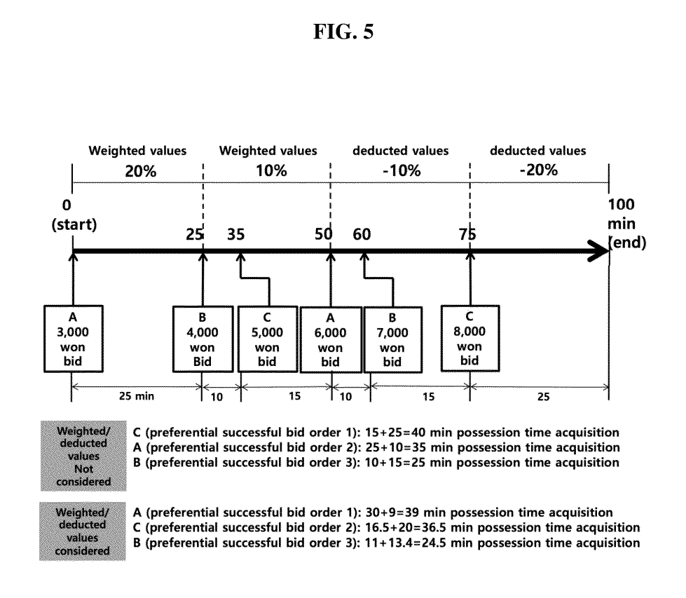

FIG. 5 is an embodiment on weighted values/deducted values about possession time.

FIG. 5 would be divided into 4 sections that for first 25 minutes+20% of weighted values to possession time, during from 25 minutes to 50 minutes+10% weighted values, during from 50 minutes to 75 minutes−10% deducted values, and −20% deducted values till 100 minutes. When weighted values and deducted values were not considered, person A's possession time is 35 minutes, person B's is 25 minutes, and person C's is 40 minutes. Order of more possession time are person C->person B->person A. Person A participated from the beginning of the auction and person C did only at the end. When said weighted values and deducted values applied, the possession time of person A would be 39 minutes, the possession time of person B's would be 24.5 minutes, the possession time of person C would be 36.5 minutes that the order is person A->C->B. In other words, the priority of person A and C are switched. Through this procedure, bidders' active participation may be induced from the beginning of the auction.

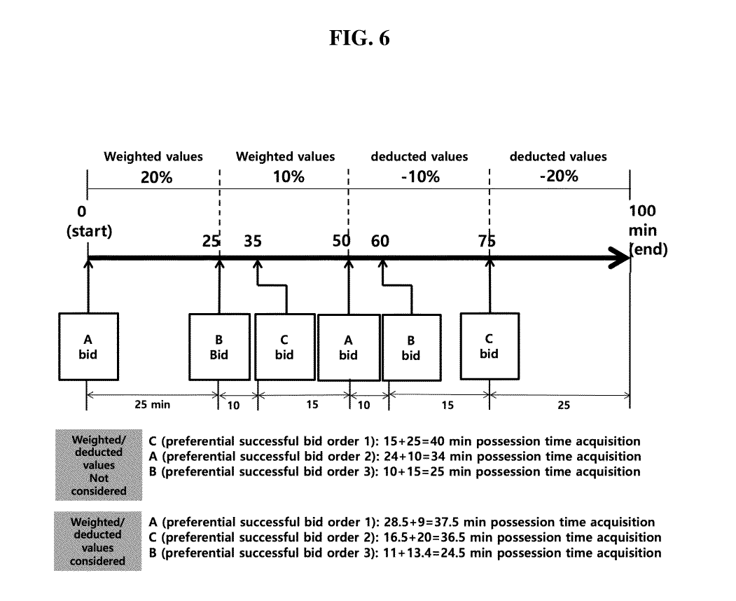

FIG. 6 is conducted example for weighted values/deducted values about participation time.

FIG. 6 would be divided into 4 sections that for first 25 minutes+20% of weighted values to participation time, +10% weighted values from 25 minutes to 50 minutes, −10% deducted values from 50 minutes to 75 minutes, and −20% deducted values till 100 minutes. When weighted values and deducted values were not given, person A's participation time is 35 minutes, person B's is 25 minutes, and person C's is 40 minutes. Order of the most possession time is like person C->person A->person B. Person A participated from the beginning of the auction and person C did only at the end. When said weighted values and deducted values are applied, the participation time of person A would be 37.5 minutes, the participation time of person B would be 24.5 minutes, the participation time of person C would be 36.5 minutes that the orders are person A->C->B. In other words, the priority between person A and C are switched. Through this procedure, bidders can be participated actively from the beginning of the auction.

Furthermore, not only beginning of an auction, request of sellers' terminals, said possession (participation) time addition/deduction module may be applied to for a specific time during auction period for giving weighted values to the possession (participation) time. For example, without beforehand notice at random time, sellers may make an announcement of From now on for 10 minutes 30% weighted values will be given” through signal processing unit (18) to consumers' terminals (2), there would be instant adding numbers of consumers participating in the auction.

According to preferable embodiment of the present invention, possession (participation) time comparing module (1715) of said possession (participation) time calculating module (171) after comparing calculated through above possession (participation) time summing module compare possession time by each consumer determines preferential successful bid orders from more possession (participation) time by each consumer. In this case, shown in FIG. 3 having most possession (participation) time orders turns out to be person A->person B->person C that person A has first priority to win the auction, then person B, and person C.

Pay attention that order of preferential successful bid is not related to the maximum bidding price from each consumer's terminal. Past bidding method is that whoever had highest bidding price won the auction, but according to the present invention priority to purchase item (priority order) is given not to the highest bid price. According to the present invention shown on FIG. 3, person A who bids 3,700 won an auction after 50 minutes since the auction had started because 3,700 won was his highest bid that person A had priority to purchase (won bids) the item. Unlike person A, person B put down 3,500 won after 20 minutes had passed. Since it is person B's maximum bid price after person A purchased if there are still products left person B can take it at a price of 3,500 won. Person C was the 3rd in a ladder that if there are still products left then he or she can purchase the item with the maximum bidding price of own 4,000 won. In general, when there is only 1 product one winner of the bid takes it. If there are more than 2 products, according to numbers of products, the winners of the auction should be matched according to the priority.

According to preferable embodiment of the present invention, right of priority in auction (hereof preferential successful bid right) to obtain the item may be transferred to someone else. In other words, like described above, a consumer with the most summed up possession time has preferential successful bid right, but depending on the consumer's opinion expression preferential successful bid management module (173) can be given to another consumer with a preferential successful bid.

For this, said preferential successful bid management module (173) transmits a preferential successful bid right that the consumer having more possession time than others through signal processing unit (18). Consumers' terminals (2) received information about said preferential successful bid right may purchase (win auction) products with maximum bidding price which oneself had inputted prior to than other consumers' terminals. More detailed, said information about preferential successful bid right includes information on preferential successful bid orders.

Furthermore, from the request of consumers' terminals (2) which received said information about preferential successful bid right, said preferential successful bid management module (173) may transmit said information about preferential successful bid right to other consumers' terminals. Hereby consumers' terminals received preferential successful bid right information actually do not obtain preferential successful bid right through possession time, but by receiving alienation of preferential successful bid right information from others can have preferential successful bids. In this case the very first received preferential successful bid right information from another person should be destroyed or updated that the consumer who transferred the information cannot use it again.

In addition, the auction system according to the present invention, (1) determines the price of the product when someone won an auction through price discount management module (15), (2) determines consumer (winner of auction) who would buy the product first among multiple consumers participated through preferential successful bid management module (17). Described about preferential successful bid management module (17) already, price discount management module (15) will be described as below.

Price discount management module (15) may won bids by deducted (discounted) as discount price from bidding starting price according to counts (number of bidding) for receiving bidding information from consumers' terminals (2). That means, multiple consumers' terminals (2) may determine the discount price based on each number of bidding.

In preferable embodiment of the present invention, price discount management module (15) includes discount price deduction module (151). Discount price deduction module (151) deducts as much as discount price from bidding start price based on the following method.

(1) First Method to Deduct Discount Price

Discount price deduction module (151) may deduct predetermined discount price from bidding start price at every bidding when product bidding management module (13) receiving bidding information from consumers' terminals (2). For example, bidding start price of 1,000,000 won relating to a bag (X) deducts discount price of 100 won at every bidding. If 3,000 bidding trials were made from multiple consumers' terminals (2) then discounted price would be 1,000,000−(3,000*100)=700,000 won. In other words, through preferential successful bid management module (17) consumers who would get first priority can pay 700,000 won to purchase the bag (X).

(2) Second Method to Deduct Discount Price

Discount price deduction module (151) may deduct predetermined discount price from bidding start price when counts for receiving bidding information by product bidding management module (13) (number of bid) from consumers' terminals (2) come to predetermined values. For example, bidding start price of 1,000,000 won relating to a bag (X) reaches 2,000 numbers of bidding then 200,000 won would be discounted. In this case, consumer(s) won bids preferentially through preferential successful bid management module (17) can pay 800,000 won (1,000,000−200,000) to get the bag (X).

(3) Third Method to Deduct Discount Price

The method to deduction discount price is not limited to described way only said first method and said second method may be combined. For examples, bidding start price of 1,000,000 won relating to a bag (X) may have 100 won discount price at every bidding. Also at the same time number of bidding reaches multiples of 1,000 then additional 50,000 won could be deducted. In this case number of bidding is 3,500 then auction winner(s) would pay 500,000 won (1,000,000−(3,500*100)−(50,000*3)) for the bag (X).

In preferable embodiment of the present invention, price discount management module (15) includes discount price addition/deduction modules (153). Depending on auction period said discount price addition/deduction modules (153) may apply weighted values/deducted values on discount price. In detail, as auction period is in progress, sellers or online discount auction system operator may apply weighted values/deducted values on the discount price discounted by bidding trials during predetermined period. For example, a discount price discounted according to biddings from 30 to 60 minutes after an auction started may be added by giving weighted values of 50%(i.e. 1.5 times). In case of said first method to deduct discount price, if 1,000 bidding trials of 3,000 bidding trials submitted from 30 to 60 minutes after the an auction started, the bid price is 1,000,000−(2,000*100)−(1,000*100*1.5)=650,000 won.

Like so, by applying weighted values/deducted values in specific period, consumers can be induced to participate in the bidding more actively. In other words, as described in the background of invention, concentrated biddings happen in auction past of the present invention at specific period (i.e. the end of the auction), on the other hand there are less biddings at the beginning of the auction. Statistically, by giving weighted values when less bidding trials are made and giving deducted values when more bidding trials are made, stable bidding process would be induced all around the auction period.

### INDUSTRIAL USABILITY

According to the present invention, longer period consumers participate in auction there are better chance of purchasing products than others. In this situation, not only at the end of auction but also at the beginning of auction, consistent auction would occur. In this way more consumers would be induced. Furthermore, consumers would advertise bidding action actively because of own action in bidding caused discounts on products. Through independent bidding action, more and more consumers would participate in bidding activities to bring virtuous circulation effect.

1. An internet auction system for mediating and managing the purchase and sale of product by receiving bid information from a plurality of customer terminals via a communication network, and the system comprises:
a product registration and management module for receiving information on a product to be auctioned off from a seller terminal and storing the received information;
a product bid management module for receiving bid information from the customer terminals and storing the received bid information, wherein the bid information includes a bidding price; and
a preferential successful bid management module for allowing a customer who has more possession time than other customers to preferentially receive a successful bid of the product,
wherein the preferential successful bid management module comprises a possession time calculation module for calculating a possession time for each customer terminal, and
the possession time is the time in which a received bidding price maintains the highest bidding price.

2. The internet auction system of claim 1,
wherein the information on the product includes auction period, and
the possession time calculation module includes a possession time summing module calculating possession time by adding up all possession time of each consumer during the auction period.

3. The internet auction system of claim 2,
wherein the possession time calculation module includes a possession time comparison module comparing possession time calculated by each consumer through the possession time summing module and determining preferential successful bid orders from more possession time by each consumer.

4. The internet auction system of claim 1,
wherein the information on the product includes auction period, and
the possession time calculation module includes a possession time adding/deducting module applying to the possession time based on the auction period.

5. The internet auction system of claim 4,
wherein the possession time addition/deduction module applying to for only specific time during the auction period for giving weighted values to the possession time by answering to the request of the seller terminal.

6. The internet auction system of claim 1,
wherein the preferential successful bid management module includes a preferential successful bid right management module transmitting preferential successful bid right information to the consumer terminals for which having by priority to win the auction of the consumers who have more possession time than other customers.

7. The internet auction system of claim 6,
wherein the preferential successful bid right management module transmits the preferential successful bid right information to other consumer terminals by answering to the request of the customer terminal receiving preferential successful bid right information.

8. An internet discount auction system for mediating and managing the purchase and sale of product by receiving bid information from a plurality of customer terminals via a communication network, and the system comprises:
a product registration and management module for receiving information on a product to be auctioned off from a seller terminal and storing the received information, wherein the information on the product includes a bidding start price;
a product bid management module for receiving bid information from the customer terminals and storing the received bid information;
a price discount management module determining winning bids by deducted as discount price from the bidding starting price according to counts for receiving the bidding information from consumer terminals; and
a preferential successful bid management module for allowing a customer who has more possession time than other customers to preferentially receive a successful bid of the product,
wherein the preferential successful bid management module includes a possession time calculation module calculating possession time of each customer terminal, wherein the possession time is from when receiving bid information from customer terminal to when receiving bid information from next customer terminal.

9. The internet discount auction system of claim 8,
wherein the price discount management module includes a discount price deduction module deducting predetermined discount price from the bidding start price whenever bidding information is received from consumer terminals by a product bid management module

10. The internet discount auction system of claim 8,
wherein the information on the product includes auction period, and
the possession time calculation module includes a possession time addition/deduction module giving weighted values or deducted values to the possession time based on the auction period.
